(19) United States
(12) Patent Application Publication
(10) Pub. No.: US 2012/0196747 A1
(43) Pub. Date: Aug. 2, 2012

(54) COMPOSITIONS AND METHODS OF INHIBITING PLANT BIOLOGY

(76) Inventor: BRIAN B. GOODWIN, Collierville, TN (US)

(21) Appl. No.: 13/363,866

(22) Filed: Feb. 1, 2012

Related U.S. Application Data
(60) Provisional application No. 61/438,494, filed on Feb. 1, 2011.

(51) Int. Cl. A01C 1/06; A01N 43/90; A01P 21/00; A01N 63/02

(52) U.S. Cl. 504/100; 504/117; 504/298

(57) ABSTRACT

A method of inhibiting the rate of at least one biological process in a seed or plant is disclosed. The method comprises contacting a part of a seed, a plant, or the locus thereof with a composition of matter, the composition of matter comprising an agriculturally acceptable complex mixture of dissolved organic material substantially devoid of one or more metal ions essential for the at least one biological process in the seed or plant. A composition of matter is also disclosed comprising a mixture of compounds derived from natural organic matter (NOM) that is substantially devoid of metal ions.

### CROSS-REFERENCE TO RELATED APPLICATIONS

This application claims the benefit of U.S. Provisional Application No. 61/438,494, filed on Feb. 1, 2011, which is hereby incorporated by reference herein in its entirety.

### TECHNICAL FIELD

The present invention relates to compositions of matter and methods for inhibiting biological activity in plants. Specifically, the method comprises contacting a part of a plant or the locus thereof with a composition of matter comprising an agriculturally acceptable complex mixture of dissolved organic material substantially devoid of metal ions.

### BACKGROUND

Various mixtures of organic compounds have been proposed in the art as fertilizer additives. Specifically, a humic acid composition, Bio-Liquid Complex™, is stated by Bio Ag Technologies International (1999) www.phelpstek.com/portfolio/humic_acid.pdf to assist in transferring micronutrients, more specifically cationic nutrients, from soil to plant.

TriFlex™ Bloom Formula nutrient composition of American Agritech is described as containing “phosphoric acid, potassium phosphate, magnesium sulfate, potassium sulfate, potassium silicate [and] sodium silicate.” TriFlex™ Grow Formula 2-4-1 nutrient composition of American Agritech is described as containing “potassium nitrate, magnesium nitrate, ammonium nitrate, potassium phosphate, potassium sulfate, magnesium sulfate, potassium silicate, and sodium silicate.” Both compositions are said to be “fortified with selected vitamins, botanical tissue culture ingredients, essential amino acids, seaweed, humic acid, fulvic acid and carbohydrates.” See, e.g., www.horticulturesource.com/product_info.php/products_id/82. These products are said to be formulated primarily for “soilless hydrogardening” (i.e., hydroponic cultivation) of fruit and flower crops, but are also said to outperform conventional chemical fertilizers in container soil gardens. Their suitability or otherwise for foliar application as opposed to application to the hydroponic or soil growing medium is not mentioned. See www.americanagritech.com/product/product_detail.asp?ID=I&pro_id_pk=4-0.

The trademark Monarch™, owned by Actagro, LLC is a fertilizer composition containing 2-20-15 primary plant nutrients with 3% non plant food organic compositions derived from natural organic materials.

Plants in general are susceptible to a variety of environmental stresses, including for example, drought, salinity, low light, water logging, disease, pests, and temperature. Conventional nutritional plant treatments are generally unable or incapable of inhibiting plant biology, indeed, most conventional nutritional plant treatments are designed for enhancing one or more of a plant's biological processes. Heretofore, it was not know how to inhibit, suspend, and/or delay one or more of a plant's biological processes, nor was it generally appreciated the benefits of such methods. While a plant's environment, more particularly a seed's environment, may possess some natural inhibition to biological processes, there is a need to provide control over such biological processes for maximizing agronomical production.

### SUMMARY

Greenhouse and field experiments have demonstrated that CP (where CP is CAS Reg. No. 1175006-56-0) can promote plant growth and development so as to increase crop yields. Physiological studies indicate that the composition of matter disclosed herein provides improved nutrient availability and mobility inside the plants. Additionally, CP augments synthesis or availability of plant hormones, and/or CP possesses synergetic actions with some of these plant hormones. At the molecular level, plant growth and development activities are controlled and/or influenced by genes and gene expression, processes that are effected by contact with CP. It is likely that CP acts through triggering or altering the expression of critical genes involved in plant growth, development, stress tolerance, and/or disease resistance.

It has now been observed that compositions of matter comprising substantially metal-free CP (hereafter also referred to as “metal-free CP”) provide inhibition of at least one biological process in a plant/seed. The inhibition of a plant/seed biological process can be for a predetermined time and can be ceased or reversed after a predetermined time. Such inhibition of a plant/seed biological processes may allow for improvements in agriculture and/or agronomical production.

Thus, in a first embodiment, a method of inhibiting the rate of at least one biological process in a seed or plant is provided. The method comprises contacting a part of a seed, a plant, or the locus thereof with a composition of matter, the composition of matter comprising an agriculturally acceptable complex mixture of dissolved organic material substantially devoid of one or more metal ions essential for the at least one biological process in the seed or plant. The at least one biological process includes, without limitation, germination, root development, growth, metabolism, reproduction, and metal ion transport.

In a second embodiment, a composition of matter is provided comprising a mixture of compounds derived from Natural Organic Matter (NOM) that is substantially devoid of metal ions. The composition of matter is preferably substantially devoid of transition metal ions.

The potent effects of the above-mentioned compositions of matter provides for wide application of these products in agriculture, horticulture, landscaping, and studies of plant biology.

### BRIEF DESCRIPTION OF THE FIGURES

FIG. 1. Graphical representation of seed germination rates verses control according to a composition of the present disclosure;

FIG. 2. Graphical representation of seed germination rates verses control according to a composition of the present disclosure;

FIG. 3. Graphical representation of seed germination rates verses control according to a composition of the present disclosure;

FIG. 4. Graphical representation of root lengths verses carbon content according to an embodiment of the present disclosure;

FIG. 5. Representation of an embodiment of a seed coating according to the present disclosure

FIG. 6. Representation of another embodiment of a seed coating according to the present disclosure;

FIG. 7. Representation of another embodiment of a coated granular form according to the present disclosure; and

FIG. 8. Representation of another embodiment of a coated granular form according to the present disclosure.

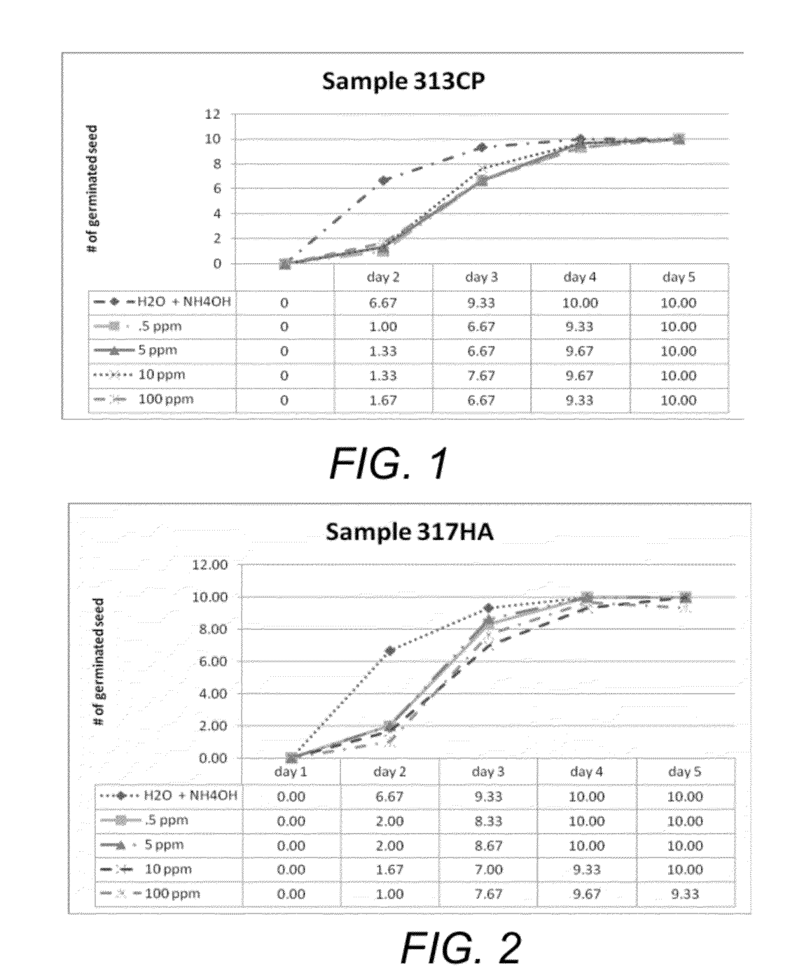

### DETAILED DESCRIPTION

### Terms and Phrases

The term “agriculturally acceptable” applied to a material or composition herein means not unacceptably damaging or toxic to a plant or its environment, and not unsafe to the user or others that may be exposed to the material when used as described herein.

A “foliar surface” herein is typically a leaf surface, but other green parts of plants have surfaces that may permit absorption of active ingredient, including petioles, stipules, stems, bracts, flowerbuds, etc., and for present purposes “foliar surfaces” will be understood to include surfaces of such green parts.

A “locus” as used herein is inclusive of a foliar surface and also includes an area in proximity to a plant or the area in which a plurality of seed is or can be sown.

“Seed treatment” as used herein refers generally to contacting a seed with a compound or composition of matter containing or comprising at least one active ingredient (a.i. or AI). The compound or composition of matter may be in any form suitable to the seed, for example, liquid, gel, emulsion, suspension, dispersion, spray, or powder. Seed treatment is inclusive of seed coating and seed dressing. In a preferred embodithent, the A.I. is metal-free CP. In another preferred embodiment, the A.I. is a source of metal ion for the metal-free CP to reverse and/or improve the biological processes of the seed.

“Seed coating” or “seed dressing” as used herein refers generally to a coating or matrix formed on at least part of the seed, the coating or matrix comprising the at least one AI. Optional compounds or agents may be included in the seed coating to facilitate the seed coating process or the disintegration/releasing of the at least one AI from the coating, or to prevent excessive dust-off or to add color to the treated seed.

The term “seed” as used herein, is not limited to any particular type of seed and can refer to seed from a single plant species, a mixture of seed from multiple plant species, or a seed blend from various strains within a plant species. The disclosed and described compositions can be utilized to treat gymnosperm seed, dicotyledonous angiosperm seed and monocotyledonous angiosperm seed.

The term “agronomical recovery” as used herein, is related to the relative resumption of biological response and/or processes of the seed/plant, for example, a predetermined time after being contacted with metal-free CP. Agronomical recovery is not limited to any particular type of biologically-related plant recovery and can include for example, recovery of some or all of germination, root development, plant maturity, weight, fruit production, reproduction, yield, survival, color, appearance, fragrance, etc. In one example, agronomical recovery includes one or more of germination, root development, plant weight, number of leaves, and stalk weight a predetermined time after contact with metal-free CP as compared to a similar plant not treated with the composition of matter disclosed herein. In one aspect, the agronomical recovery includes an improvement of one or more of germination, root development, plant weight, number of leaves, and stalk weight a predetermined time after said biological inhibition.

As used herein, the phrases “substantially devoid of metal” and/or “substantially metal-free” and/or “metal-free” refers to compositions of matter that contain metal ions in amount less than that necessary to produce an agrochemically viable biological effect on a plant and/or seed when said plant or seed is contacted with said composition of matter. Such amounts of metal ions are inclusive of no measurable amounts of metal ions (e.g., zero metal ion content) and also, is inclusive of trace amounts of metal ions. For example, a composition of matter may contain metal ions in the form of aqueous soluble salts in trace amounts that are incapable of producing an agrochemically viable biological effect, such as germination, root development, plant health, etc, as compared to a similar composition of matter having metal ions in greater amounts. By way of example, a composition of matter is “substantially devoid of metal” if (i) the amount of metal ion is measurably different from that of a similar composition of matter having metal ions; and (ii) a biological process is inhibited by the composition of matter “substantially devoid of metal” but otherwise not inhibited to the same extent than that of a similar composition of matter having metal ions.

The term “granular” and the phrase “granular form” as used herein, refers to granules, particulates, beads, and combinations thereof. For example, granular forms are those suitable for dispensing equipment commonly used in an agricultural setting. Granular forms may be of any shape or size suitable for use in an agricultural setting or in agricultural equipment.

The composition of matter disclosed herein comprises a mixture of organic molecules isolated and extracted from sources rich in natural organic matter into an aqueous solution. The natural organic matter is primarily derived from plant materials that have been modified to varying degrees over time in a soil environment. Some of the plant materials have been recently deposited in the environment. At least a part of the natural organic matter has passed through a partial process of humification to become partially humified natural organic matter. Humification includes microbial, fungal, and/or environmental (heat, pressure, sunlight, lightning, fire, etc.) degradation and/or oxidation of natural organic matter. Most preferably, the composition of matter contains natural organic matter that has not substantially undergone humification (partially humified natural organic matter). In one aspect, the natural organic matter is obtained from environments typically containing or providing 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 95 ppm, 100 ppm, or up to 500 ppm of dissolved organic matter (DOM). In other aspects, the natural organic matter is obtained from environments typically containing or providing about 500 ppm, 1000 ppm, 1500 ppm, 2000 ppm, 2500 ppm, 3000 ppm or more DOM. In a first embodiment, one or more metal ions essential to biological processes in plants and/or seeds are substantially removed from the composition of matter, herein after also referred to as “metal-free CP” or “MFCP”.

Natural organic matter is extremely complex, with thousands of compounds generally present, depending upon the source and the environmental conditions prevalent about the source. Humic substances such as Fulvic Acid (CAS Reg. No. 479-66-3) and Humic Acid (CAS Reg. No. 1415-93-6) are examples of organic complexes that are derived from natural organic matter, however, CP is chemically and biologically unique from Fulvic and Humic acid, as detailed below. Humic substances such as Fulvic Acid and Humic Acid generally contain appreciable amounts of metal ions, either naturally or from processing. In some aspects, metal-free versions of Humic substances such as Fulvic Acid and Humic Acid are used as controls verses the metal-free compositions of matter disclosed in the current application.

CP contains dissolved organic matter, the organic matter being formed during the process of humification as described above, such as microbial, fungicidal, and/or environmental (heat, pressure, sunlight, lightning, fire, etc.) degradation processes. Other natural or synthetic natural organic matter degradation processes may be involved or may be used. In one aspect, CP contains predominately natural organic matter that has not undergone substantial humification (e.g., partially humified natural organic matter). The amount of humification may be determined and characterized using known methods, for example, by 13C NMR.

In one aspect, CP is obtained by removing a natural organic matter from its source, optionally processing, and/or concentrating to provide a CP composition having a dissolved organic matter (DOM) concentration level of about 10×, 25×, 50×, 100×, 200×, 300×, 400×, 500×, 600×, 700×, 800×, 900×, 1000×, 1500×, 2000×, 2500×, 3000×, 3500×, 4000×, 4500×, or 5000× relative to its original source. In another aspect, CP concentrations of dissolved organic matter (DOM) concentration level can be about 7500×, 10,000×, 15,000×, 20,000×, 25,000×, and up to 50,000×. CP compositions may be adjusted such that the concentration of DOM is between about 10 ppm to about 700,000 ppm. Preferably, CP may be adjusted such that the concentration of DOM is between about 1000 ppm to about 500,000 ppm. CP compositions may be adjusted to a DOM value represented by any ppm value between 1000 ppm and 50,000 ppm, inclusive of any ppm value in 500 ppm increments (e.g., 10,500 ppm, 11,000 ppm, 11,500 ppm, 12,000 ppm, etc.) in aqueous solution. Other DOM concentrations may be used, for example, an extremely concentrated composition of between about 75,000 ppm and about 750,000 ppm can be prepared. For example, a concentrate of about 30,000× that of the original source can contain about 550,000 ppm of DOM. In certain aspects, CP compositions are approximately between about 91% to about 99% water, the remaining organic material being primarily DOM with minor amounts of alkali-, alkali earth-, and transition metal salts. In yet other aspects, the DOM of the CP composition has been dried or lyophilized in a form suitable for reconstitution with an aqueous solution. Prior to or subsequent to the processes described above, substantially all of the metal ions can be removed from the CP to provide a metal-free CP product.

Metal-free CP compositions contain a complex mixture of substances, typically a heterogeneous mixture of compounds for which no single structural formula will suffice. Detailed chemical and biological testing has shown that CP (and metal-free CP) is a unique composition both in its biological effect on plants and its chemical composition compared to Humic and Fulvic acids. Elemental and spectroscopic characterization of CP (and metal-free CP) material differentiates it from most other humic-based organic complexes, such as Humic and Fulvic Acids, as further discussed below. Blending of metal-free CP compositions may be performed to provide consistency of material and to compensate for the normal variations of a naturally-derived material.

Metal-free CP compositions may be applied to the seed, foliage, or to any other part of the plant or its locus. Application rate of metal-free CP can be between about 0.01 gram/hectare to about 10.0 gram/hectare dry weight, between about 0.2 gram/hectare to about 2.0 gram/hectare dry weight, between 0.3 gram/hectare to about 1.5 gram/hectare dry weight, or between about 0.4 gram/hectare to about 1.0 gram/hectare dry weight applied in the soil or as a foliar application to the foliage or the locus of the plant.

### Characterization Methods

The organic compounds making up CP and metal-free CP can be characterized in a variety of ways (e.g., by molecular weight, distribution of carbon among different functional groups, relative elemental composition, amino acid content, carbohydrate content, etc.). In one aspect, metal-free CP was characterized relative to known standards of humic-based substances. In another aspect, metal-free CP was characterized functionally to known standards of humic-based substances that were stripped of metal ions (metal-free standards of humic-based substances).

For purposes of characterizing carbon distribution among different functional groups, suitable techniques include, without limitation, 13C-NMR, elemental analysis, Fourier transform ion cyclotron resonance mass spectroscopy (FTICR-MS) and Fourier transform infrared spectroscopy (FTIR). The chemical characterization of CP and Humic substance standards were carried out using Electro spray Ionization Fourier Transform Ion Cyclotron Resonance Mass Spectroscopy (ESI-FTICR-MS), Fourier Transform Infrared Spectroscopy (FTIR) and elemental analysis for metals using ICP-AES, conducted by Huffman Laboratories, Inc. and the University of Washington.

Elemental, molecular weight, and spectroscopic characterization of CP is consistent with an organic complex that consists primarily of lignin and tannin compounds (and mixtures of condensed and un-condensed tannin), condensed aromatics and trace amounts of lipid and inorganics. Thousands of compounds are present, with molecular weights ranging from 225 to 700 daltons, the majority of compounds having between about 10 to about 39 carbon atoms per molecule. CP compositions are generally composed of carbon, oxygen, and hydrogen, with small amounts of nitrogen, and sulfur. CP compositions may also contain metals at levels above 5 weight percent. Thus, in one aspect, metal-free CP is a CP composition of matter comprising a metal ion content of less than 5 weight percent, less than 4 weight percent, less than 3 weight percent, less than 2 weight percent, less than 1 weight percent, less than 0.9 weight percent, less than 0.8 weight percent, less than 0.7 weight percent, less than 0.6 weight percent, less than 0.5 weight percent, less than 0.4 weight percent, less than 0.3 weight percent, less than 0.2 weight percent, less than 0.1 weight percent, less than 0.09 weight percent, less than 0.08 weight percent, less than 0.07 weight percent, less than 0.06 weight percent, less than 0.05 weight percent, less than 0.04 weight percent, less than 0.03 weight percent, less than 0.02 weight percent, less than 0.01 weight percent, less than 0.009 weight percent, less than 0.008 weight percent, less than 0.007 weight percent, less than 0.006 weight percent, less than 0.005 weight percent, less than 0.004 weight percent, less than 0.003 weight percent, less than 0.002 weight percent, less than 0.001 weight percent, less than 0.0009 weight percent, less than 0.0008 weight percent, less than 0.0007 weight percent, less than 0.0006 weight percent, less than 0.0005 weight percent, less than 0.0004 weight percent, less than 0.0003 weight percent, less than 0.0002 weight percent, less than 0.0001 weight percent, less than 0.00009 weight percent, less than 0.00008 weight percent, less than 0.00007 weight percent, less than 0.00006 weight percent, less than 0.00005 weight percent, less than 0.00004 weight percent, less than 0.00003 weight percent, less than 0.00002 weight percent, less than 0.00001 weight percent, less than 0.000009 weight percent, less than 0.000008 weight percent, less than 0.000007 weight percent, less than 0.000006 weight percent, less than 0.000005 weight percent, less than 0.000004 weight percent, less than 0.000003 weight percent, less than 0.000002 weight percent, less than 0.000001 weight percent, less than 0.0000009 weight percent, less than 0.0000008 weight percent, less than 0.0000007 weight percent, less than 0.0000006 weight percent, less than 0.0000005 weight percent, less than 0.0000004 weight percent, less than 0.0000003 weight percent, less than 0.0000002 weight percent, less than 0.0000001 weight percent, less than 0.00000009 weight percent, less than 0.00000008 weight percent, less than 0.00000007 weight percent, less than 0.00000006 weight percent, less than 0.00000005 weight percent, less than 0.00000004 weight percent, less than 0.00000003 weight percent, less than 0.00000002 weight percent, or less than 0.00000001 weight percent. Metal ion content of the metal-free CP composition of matter can be less than one part per million, less than one part per billion, or less.

The elemental composition of the dissolved solids typically present in CP compositions is given in Table A. If the organic compounds are separated from the inorganic elements, the elemental breakdown is: C 55%, H 4%, O 38%, N 1.8%, and S 2.2%.

TABLE A
Average Elemental Composition of dissolved solids, based upon average
values from 10 different CP lots.

| Element | % |
|---|---|
| Carbon | 35.1 |
| Oxygen | 24.6 |
| Hydrogen | 2.5 |
| Sulfur | 2.1 |
| Nitrogen | 1.3 |
| Potassium | 27.3 |
| Iron | 6.1 |
| Calcium | 0.2 |
| Sodium | 0.2 |
| Phosphorous | 0.1 |
| Other | 0.5 |

Among the classes of organic compounds present in CP, analysis generally reveals that there are lignin and tannin (mixture of condensed and un-condensed), condensed aromatics, unidentified substances and some lipids present. In one aspect, the CP composition is characterized in that at least 10% of the total % compounds present in the CP composition is tannins and/or condensed tannins. In another aspect, the CP composition is characterized in that at least 15% of the total % compounds present in the CP composition is tannins and/or condensed tannins. In another aspect, the CP composition is characterized in that at least 20% of the total % compounds present in the CP composition is tannins and/or condensed tannins. Each of these classes of compounds is further characterized by a rather narrow Mw range and number of carbons/molecule. The breakdown of the number and percentage of each of the various compound classes, their MW's and carbon atoms/molecule (Carbon Range) for a representative sampling of CP (essentially with or without metal ions) is given in Table B1.

TABLE B1
Compound Classes in CP along with size and carbon ranges for
compounds in each class.

| Compound | # | | Size Range | |
|---|---|---|---|---|
| Class | Compounds | % of Total | (daltons) | Carbon Range |
| Lignin | 1139 | 57 | 226-700 | 11 to 39 |
| Tannin | 587 | 30 | 226-700 | 10 to 31 |
| Condensed | 220 | 11 | 238-698 | 13 to 37 |
| Aromatic | | | | |
| Lipid | 18 | 1 | 226-480 | 14 to 30 |
| Carbohydrate | 1 | 0 | 653 | 24 |
| Other | 23 | 1 | 241-651 | 12 to 33 |

Based upon composite of 3 different production batches. Results for individual batches are very similar.

A breakdown of the number and percentage of each of the various compound classes, their MW's and carbon atoms/molecule (Carbon Range) for a second representative sampling based upon an average of 3 different production batches (essentially with or without metal ions) for the composition of matter is given in Table B2.

TABLE B2
Compound Classes in the composition of matter, along with size and
carbon ranges for compounds in each class.

| Compound | # | | Size Range | |
|---|---|---|---|---|
| Class | Compounds | % of Total | (daltons) | Carbon Range |
| Lignin | 711 | 56 | 226-700 | 11 to 39 |
| Tannin | 410 | 33 | 226-700 | 10 to 31 |
| Condensed | 122 | 10 | 238-698 | 13 to 37 |
| Aromatic | | | | |
| Lipid | 12 | ~1 | 226-480 | 14 to 30 |
| Carbohydrate | 1 | 0 | 653 | 24 |
| Other | 14 | ~1 | 241-651 | 12 to 33 |

Based upon average of 3 different CP production batches. Results for individual batches are very similar.

Table C, summarizes the oxygen-to-carbon (O/C) and hydrogen-to-carbon (H/C) ratios used in defining the classes described above. In one aspect, the CP composition is characterized in that the O/C ratio of the dissolved organic matter is greater than about 0.4 as measured by mass spectroscopy. In one aspect, the CP composition (essentially with or without metal ions) is characterized in that the H/C ratio of the dissolved organic matter is greater than about 0.8 as measured by mass spectroscopy. In another aspect, the CP composition (essentially with or without metal ions) is characterized in that the H/C ratio of the dissolved organic matter is greater than about 0.85 as measured by mass spectroscopy.

TABLE C
Elemental Ratios and chemical classifications used in characterizing
CP samples.

| Class | O/C | H/C | Aromaticity Index |
|---|---|---|---|
| Lignin | 0.15-0.6 | 0.6-1.7 | <0.7 |
| Tannin | 0.6-1.0 | 0.5-1.4 | <0.7 |
| Condensed | 0.1-0.7 | 0.3-0.7 | >0.7 |
| Aromatic | | | |
| Lipid | 0-0.2 | 1.8-2.2 | |
| Carbohydrate | 0.6-1.0 | 1.8-2.2 | |

Preparation and Comparison of Metal-Free CP with Metal-Free Humic Substance Standards

Comparative elemental and structural characterization of metal-free Humic Substances verses metal-free CP was performed. Three humic substances standards from the International Humic Substances Society were used: Leonardite Humic Acid (LHA), Pahokee Peat Humic Acid (PPHA), and Suwannee River Fulvic Acid II (SRFA). Each humic substance standards and each CP sample was analyzed by FTIR and ESI-FTICR-MS. A portion of each humic substance standard was dissolved in NH₄OH/water for the ESI-FTICR-MS analysis. Three samples of CP (CP#60, CP#75, and CP#99) were prepared for analysis with cation exchange resin (AG MP-50, Bio-Rad Laboratories, Hercules, Calif.). Three samples of the composition of matter (CP#1, CP #2, and CP#3) were prepared for analysis with cation exchange resin (AG MP-50, Bio-Rad Laboratories, Hercules, Calif.). Comparison of the Humic Substance standards and each sample of the composition of matter is presented in Table D.

TABLE D
Comparison of humic substance standards and each CP sample.

| Sample | O/C | H/C | DBE | Avg. MW |
|---|---|---|---|---|
| Suwannee River Fulvic Acid (SRFA) | 0.39 | 1.01 | 12.7 | 445.7 |
| Pahokee Peat Humic Acid (PPHA) | 0.34 | 0.75 | 16.29 | 429.8 |
| Leonardite Humic Acid (LHA) | 0.3 | 0.79 | 15.8 | 423.6 |
| Metal-free CP#60 | 0.54 | 0.87 | 13.7 | 472.9 |
| Metal-free CP#75 | 0.54 | 0.89 | 13.23 | 456.9 |
| Metal-free CP#99 | 0.5 | 0.91 | 13.23 | 455.7 |

Table D indicates that there are major differences between the metal-free Humic Substances standards and the metal-free CP samples. For example, the 0/C ratio is less than 0.4 in all of the Humic Substances but is over 0.5 for the CP samples. The DBE for the CP samples is also significantly lower than for the Humic Acid Standards and the average MW is greater.

Based on mass spectral analysis, there are a number of compounds present in the metal-free CP samples that are substantially absent or greatly reduced in the metal-free Humic Substance standards. In particular, at least one component of metal-free CP may correspond with one or more tannin compounds. By comparison, in the metal-free Humic Substance standards, % tannin compounds are present in a small amount. For example, in the metal-free Fulvic Acid standard and in the metal-free Humic Acid standards, both metal-free standards are at least 3×-4× less than the % tannins found in the metal-free CP samples, as shown in Table E.

TABLE E
Number and % tannins in Humic Substance Standards verses CP.

| | | % |
|---|---|---|
| Sample | # tannins | of tannin compounds |
| Suwannee River Fulvic Acid (SRFA) | 192 | 8.8 |
| Pahokee Peat Humic Acid (PPHA) | 9 | 1.2 |
| Leonardite Humic Acid (LHA) | 22 | 1.2 |
| metal-free CP#60 | 441 | 35.2 |
| metal-free CP#75 | 357 | 34.6 |
| metal-free CP#99 | 432 | 28.3 |

Comparing the Fourier Transform Infrared (FTIR) spectra for the metal-free IHSS standards and metal-free CP samples, there are similarities, primarily in the region from 1600 to 1800 cm⁻¹. In both sets of samples we see a very strong peak at around 1700 cm⁻¹ due to the C═O stretch from a carboxyl functional group and a peak in the 1590 to 1630 region which is consistent with a C═C bond from alkenes or aromatics. However, significant differences in the region from 700 to 1450 cm⁻¹ are observed. Peaks at 1160 to 1210 are present in all the spectra and are from the C—O bond of alcohols, ethers, esters and acids. The biggest difference is the peak at 870 cm⁻¹ in the metal-free CP samples, which is absent in the IHSS standards. This peak may be due to the C—H bond of alkenes and aromatics.

Based on the above chemical, elemental and structural characterization, metal-free CP is chemically and biologically unique from Humic and Fulvic acids (or their metal free compositions) or combinations thereof. Further, as a result of the nature and extent of biological inhibition, gene regulation and over all effect of metal-free CP with respect to plant biology, metal-free CP is unique to that of known humic and/or fulvic acid compositions and treatments, for which such stress resistant activity and gene regulation properties are generally lacking in quality and quantity. Other beneficial agronomical attributes of metal-free CP may be present or result from the methods of treatment and/or the gene regulation obtained from metal-free CP.

Based on the characterization data, the CP (whether metal-free or not) may contain relatively small molecules or supramolecular aggregates with a molecular weight distribution of about 300 to about 18,000 daltons. Included in the organic matter from which the mixture of organic molecules are fractionated are various humic substances, organic acids and microbial exudates. The mixture is shown to have both aliphatic and aromatic characteristics. Illustratively, the carbon distribution shows about 35% in carbonyl and carboxyl groups; about 30% in aromatic groups; about 18% in aliphatic groups, about 7% in acetal groups; and about 12% in other heteroaliphatic groups.

In some embodiments, the mixture of compounds in the metal-free CP comprises organic molecules or supramolecular aggregates with a molecular weight distribution of about 300 to about 30,000 daltons, for example, about 300 to about 25,000 daltons, about 300 to about 20,000 daltons, or about 300 to about 18,000 daltons.

Characterizing carbon distribution among different functional groups, suitable techniques can be used include without limitation 13C-NMR, elemental analysis, Fourier transform ion cyclotron resonance mass spectroscopy (FTICR-MS) and Fourier transform infrared spectroscopy (FTIR).

In one aspect, carboxy and carbonyl groups together account for about 25% to about 40%, for example about 30% to about 37%, illustratively about 35%, of carbon atoms in the mixture of organic compounds of the metal-free CP.

In another aspect, aromatic groups account for about 20% to about 45%, for example about 25% to about 40% or about 27% to about 35%, illustratively about 30%, of carbon atoms in the mixture of organic compounds of the metal-free CP.

In another aspect, aliphatic groups account for about 10% to about 30%, for example about 13% to about 26% or about 15% to about 22%, illustratively about 18%, of carbon atoms in the mixture of organic compounds of the metal-free CP.

In another aspect, acetal and other heteroaliphatic groups account for about 10% to about 30%, for example about 13% to about 26% or about 15% to about 22%, illustratively about 19%, of carbon atoms in the mixture of organic compounds of the metal-free CP.

In another aspect, the ratio of aromatic to aliphatic carbon is about 2:3 to about 4:1, for example about 1:1 to about 3:1 or about 3:2 to about 2:1 in the metal-free CP.

In a particular illustrative aspect, carbon distribution in the mixture of organic compounds of the metal-free CP is as follows: carboxy and carbonyl groups, about 35%; aromatic groups, about 30%; aliphatic groups, about 18%, acetal groups, about 7%; and other heteroaliphatic groups, about 12%.

Elemental composition of the organic compounds of the metal-free CP is independently in one series of embodiments as follows, by weight: carbon, about 50% to about 60%, illustratively about 55%; hydrogen, about 3% to about 5%, illustratively about 4%; oxygen, about 20% to about 30%, illustratively about 25%; nitrogen, about 0.5% to about 3%, illustratively about 1.3%; sulfur, about 0.2% to about 4%, illustratively about 2%.

Among classes of organic compounds that can be present in the metal-free CP are, in various aspects, amino acids, carbohydrates (monosaccharides, disaccharides and polysaccharides), sugar alcohols, carbonyl compounds, polyamines, lipids, and mixtures thereof. These specific compounds typically are present in minor amounts, for example, less than 5% of the total % of compounds. Examples of amino acids that can be present include without limitation arginine, aspartic acid, glutamic acid, glycine, histidine, isoleucine, serine, threonine, tyrosine and valine. Examples of monosaccharide and disaccharide sugars that can be present include without limitation glucose, galactose, mannose, fructose, arabinose, ribose and xylose.

Based on the above chemical, elemental and structural characterization, the metal-free CP is chemically and biologically unique from either Humic and Fulvic acids or their metal-free forms. Further, as a result of the nature and extent of biological inhibition of plant/seed and of gene regulation, it is generally believed that the metal-free CP is unique to that of known humic and/or fulvic acid compositions, for which such activity and properties are generally lacking in quality and quantity. Other agrochemically beneficial inhibition of plant function by the metal-free CP may be present or result from the methods of treatment and/or the gene regulation obtained from the metal-free CP.

A suitable mixture of organic compounds can be found, for example, as one of many components in products marketed as Carbon Boost-S soil solution and KAFE™-F foliar solution of Floratine Biosciences, Inc. (FBS). Information on these products is available at www.fbsciences.com. Thus, exemplary compositions of aspects disclosed and described herein can be prepared by removing substantially all of the metal ions present in Carbon Boost™-S or KAFE™-F foliar solution, for example, using an ion-exchange media and/or HPLC. In one aspect, the active ingredient is the metal-free form of CAS Reg. No. 1175006-56-0, which corresponds, by way of example, to CP.

The amount of the CP that should be present in the composition for providing biological inhibition and/or gene regulation depends on the particular organic mixture used and/or the plant/seed. The amount should not be so great as to result in a physically unstable composition, for example by exceeding the limit of solubility of the mixture in the composition, or by causing other essential components to fall out of solution. On the other hand, the amount should not be so little as to fail to provide biological inhibition, or gene regulation when applied to a target plant species. For any particular organic mixture, one of skill in the art can, by routine formulation stability and bioefficacy testing, optimize the amount of organic mixture in the composition for any particular use.

Particularly where a mixture of organic compounds, as found, for example, in the commercially available formulations sold under the tradenames Carbon Boost™-S and KAFE™-F, is used, the amount of the resultant metal-free CP needed in a inhibition composition will often be found to be remarkably small.

Optionally, additional components can lie present in the composition of matter comprising the metal-free CP. For example, the composition can further comprise a second component. The second component can be of at least one agriculturally acceptable source of a plant nutrient. The second component can also be a pesticide, where the term “pesticide” herein refers to at least one herbicide, insecticide, fungicide, bactericide, anti-viral; nematocide, or a combination thereof.

Methods of use of the composition as described herein for plant and/or seed treating for biological inhibition of a plant/seed are further disclosed. The composition can be applied to a single plant/seed (e.g., a houseplant or garden ornamental) or to an assemblage of plants occupying an area. In some embodiments, the composition is applied to an agricultural or horticultural crop, more especially a food crop. A “food crop” herein means a crop grown primarily for human consumption. Methods of the present invention are appropriate both for field use and in protected cultivation, for example, greenhouse use.

While the present methods can be beneficial for gramineous (belonging to the grass family) crops such as cereal crops, including corn, wheat, barley, oats and rice, they are also highly appropriate for non-gramineous crops, including vegetable crops, fruit crops, broad-leaved field crops such as soybeans, seed crops or a crop of any species grown specially to produce seed. The terms “fruit” and “vegetable” herein are used in their agricultural or culinary sense, not in a strict botanical sense; for example, tomatoes, cucumbers and zucchini are considered vegetables for present purposes, although botanically speaking it is the fruit of these crops that is consumed.

Vegetable crops for which the present methods can be found useful include without limitation:

leafy and salad vegetables such as amaranth, beet greens, bitterleaf, bok choy, Brussels sprout, cabbage, catsear, celtuce, choukwee, Ceylon spinach, chicory, Chinese mallow, chrysanthemum leaf, corn salad, cress, dandelion, endive, epazote, fat hen, fiddlehead, fluted pumpkin, golden samphire, Good King Henry, ice plant, jambu, kai-lan, kale, komatsuna, kuka, Lagos bologi, land cress, lettuce, lizard's tail, melokhia, mizuna greens, mustard, Chinese cabbage, New Zealand spinach, orache, pea leaf, polk, radicchio, rocket (arugula), samphire, sea beet, seakale, Sierra Leone bologi, soko, sorrel, spinach, summer purslane, Swiss chard, tatsoi, turnip greens, watercress, water spinach, winter purslane and you choy;
flowering and fruiting vegetables such as acorn squash, Armenian cucumber, avocado, bell pepper, bitter melon, butternut squash, caigua, Cape gooseberry, cayenne pepper, chayote, chili pepper, cucumber, eggplant (aubergine), globe artichoke, luffa, Malabar gourd, parwal, pattypan squash, perennial cucumber, pumpkin, snake gourd, squash (marrow), sweetcorn, sweet pepper, tinda, tomato, tomatillo, winter melon, West Indian gherkin and zucchini (courgette);
podded vegetables (legumes) such as American groundnut, azuki bean, black bean, black-eyed pea, chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, urad bean, velvet bean, winged bean and yardlong bean;
bulb and stem vegetables such as asparagus, cardoon, celeriac, celery, elephant garlic, fennel, garlic, kohlrabi, kurrat, leek, lotus root, nopal, onion, Prussian asparagus, shallot, Welsh onion and wild leek;
root and tuber vegetables, such as ahipa, arracacha, bamboo shoot, beetroot, black cumin, burdock, broadleaf arrowhead, camas, canna, carrot, cassava, Chinese artichoke, daikon, earthnut pea, elephant-foot yam, ensete, ginger, gobo, Hamburg parsley, horseradish, Jerusalem artichoke, jicama, parsnip, pignut, plectranthus, potato, prairie turnip, radish, rutabaga (swede), salsify, scorzonera, skirret, sweet potato, taro, ti, tigemut, turnip, ulluco, wasabi, water chestnut, yacon and yam; and
herbs, such as angelica, anise, basil, bergamot, caraway, cardamom, chamomile, chives, cilantro, coriander, dill, fennel, ginseng, jasmine, lavender, lemon balm, lemon basil, lemongrass, marjoram, mint, oregano, parsley, poppy, saffron, sage, star anise, tarragon, thyme, turmeric and vanilla.

Fruit crops for which the present methods can be found useful include without limitation: apple, apricot, banana, blackberry, blackcurrant, blueberry, boysenberry, cantaloupe, cherry, citron, clementine, cranberry, damson, dragonfruit, fig, grape, grapefruit, greengage, gooseberry, guava, honeydew, jackfruit, key lime, kiwifruit, kumquat, lemon, lime, loganberry, longan, loquat, mandarin, mango, mangosteen, melon, muskmelon, orange, papaya, peach, pear, persimmon, pineapple, plantain, plum, pomelo, prickly pear, quince, raspberry, redcurrant, starfruit, strawberry, tangelo, tangerine, tayberry, ugli fruit and watermelon.

Seed crops for which the present methods can be found useful include without limitation: specialized crops used to produce seed of any plant species, for which the present methods can be found useful include, in addition to cereals (e.g., barley, corn (maize), millet, oats, rice, rye, sorghum (milo) and wheat), non-gramineous seed crops such as buckwheat, cotton, flaxseed (linseed), mustard, poppy, rapeseed (including canola), safflower, sesame and sunflower.

Other crops, not fitting any of the above categories, for which the present methods can be found useful include without limitation sugar beet, sugar cane, hops and tobacco.

Each of the crops listed above can have its own particular biological inhibition needs. Further optimization of compositions described herein for particular crops can readily be undertaken by those of skill in the art, based on the present disclosure, without undue experimentation.

Methods of using the compositions disclosed and described herein comprise applying a composition as described herein to a seed, to a foliar surface of a plant, or to a locus of the plant or seed.

Compositions disclosed and described herein can be applied using any conventional system for applying liquid or solid to a seed or foliar surface or locus. Most commonly, application by spraying will be found most convenient, but other techniques, including application by tumbling, brush or by rope-wick can be used if desired. For spraying, any conventional atomization method can be used to generate spray droplets, including hydraulic nozzles and rotating disk atomizers. Introduction of the composition into an irrigation system can be used.

For foliage surface or locus applications, the application rate of the composition can be between about 0.001 gram/hectare to about 100.0 gram/hectare dry weight, between about 0.2 gram/hectare to about 2.0 gram/hectare dry weight, between 0.3 gram/hectare to about 1.5 gram/hectare dry weight, or between about 0.4 gram/hectare to about 1.0 gram/hectare dry weight applied in the soil or as a foliar application to the foliage or the locus of the plant.

Compositions disclosed and described herein can be provided in concentrate form, (e.g., liquid, gel, or reconstitutable powder form), suitable for further dilution and/or mixing in water prior to application to the seed, plant, or locus. Alternatively, they can be provided as a ready-to-use solution for direct application. Because compositions disclosed and described herein can be combined with other fertilizer solutions and/or with pesticide solutions, they can be diluted and/or reconstituted by mixing with such other solutions.

The above concentrate compositions are suitable for further dilution. For application to plant foliage, a concentrate composition can be diluted up to about 600-fold or more with water, more typically up to about 100-fold or up to about 40-fold. Illustratively, a concentrate product can be applied at about 0.1 to about 30 l/ha, for example about 5 to about 25 l/ha, in a total application volume after dilution of about 60 to about 600 l/ha, for example about 80 to about 400 l/ha or about 100 to about 200 l/ha.

For seed treatment applications, a concentrate composition can be diluted up to about 600-fold or more with water, more typically up to about 100-fold or up to about 40-fold. Illustratively, a concentrate product can be applied at about 0.1 mg/Kg seed to about 100 mg/Kg seed, for example about 0.1 mg/Kg seed, 0.5 mg/Kg seed, 0.75 mg/Kg seed, 1.0 mg/Kg seed, 1.25 mg/Kg seed, 1.5 mg/Kg seed, 1.75 mg/Kg seed, 2.0 mg/Kg seed, 2.5 mg/Kg seed, 3.0 mg/Kg seed, 3.5 mg/Kg seed, 4.0 mg/Kg seed, 4.5 mg/Kg seed, 5.0 mg/Kg seed, 5.5 mg/Kg seed, 6.0 mg/Kg seed, 6.5 mg/Kg seed, 7.0 mg/Kg seed, 7.5 mg/Kg seed, 8.0 mg/Kg seed, 8.5 mg/Kg seed, 9.0 mg/Kg seed, 9.5 mg/Kg seed, and 10.0 mg/Kg seed. A concentrate product can also be applied at about 15 mg/Kg, 20 mg/Kg, 25 mg/Kg, and 30 mg/Kg.

Application solutions prepared by diluting concentrate compositions as described above represent further aspects of the compositions and methods disclosed and described herein.

### EXPERIMENTAL

Samples of CP, humic acid (HA), and fulvic acid (FA) were treated with a cation exchange resin (BioRad, AG-50) to reduce metal ion levels to at least less than 1 ppm. The samples was diluted to different concentrations to determine whether concentration could be a discriminating factor during germination and/or root development.

Experiments were conducted using a series of samples, including metal-free CP, and metal-free humic acid and fulvic acid samples, all derived from natural organic matter (NOM), were studied to determine their affect on germination and early root development of tomato seeds.

Sample 313 is a metal-free CP product as presently disclosed. Comparative Sample 318FA is fulvic acid was a standard reference material obtained from the International Humic Substances Society (Suwannee River Fulvic Acid, catalog #2S101F) passed through the cation exchange resin. Comparative Sample 317HA is a humic acid sample commercially available from Helena Chemical, Memphis, Tenn. (Hydra-Hume Fertilizer) passed through the cation exchange resin. The following concentrations for the metal free CP samples and comparative samples were used: 0.5, 5, 10, and 100 mg/L Carbon (as determined by measuring Total Organic Carbon in each sample). For metal-free CP Sample 313 and comparative Sample 317HA, it was further necessary to add base (ammonium hydroxide, NH4OH) to the solution to achieve complete dissolution of organic matter. Comparative Sample (318FA) dissolved completely in water, so the addition of NH4OH was not required, and an additional concentration of 500 mg/L Carbon was tested for this sample. Germination was tested using only deionized water (with and without the addition of NH4OH) as a control. Each experiment was conducted in triplicate, using Petri dishes with 10 seeds for each sample at each concentration.

Red cherry tomatoes seeds typically utilized for hydroponic cultivation were used. In Petri dishes, ten seeds were placed on filter paper (Fisher, Qualitative P5) and contacted with approximately 1 ml of the Samples. The Petri dishes were hermetically sealed using Parafilm to avoid evaporation and then wrapped in aluminum foil and kept in the dark at room temperature to avoid the growth of mold. The germination process was complete after only five days and the root length was measured after seven days.

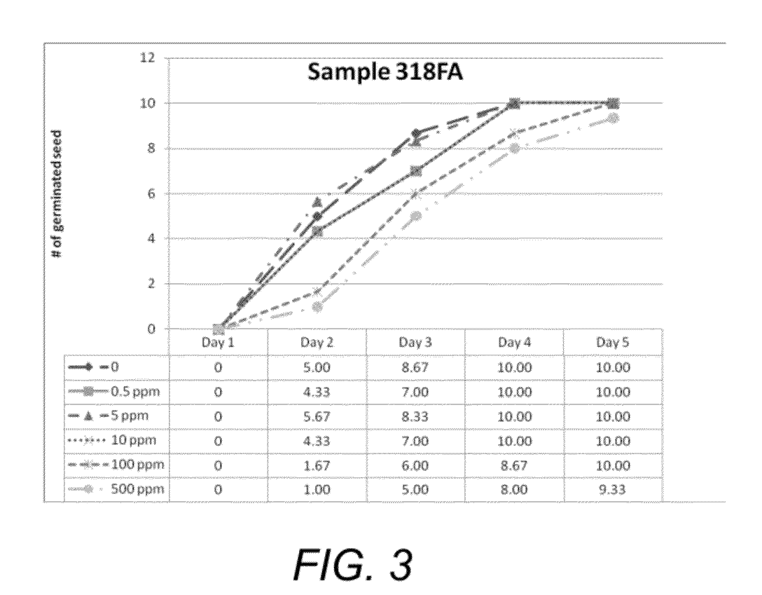

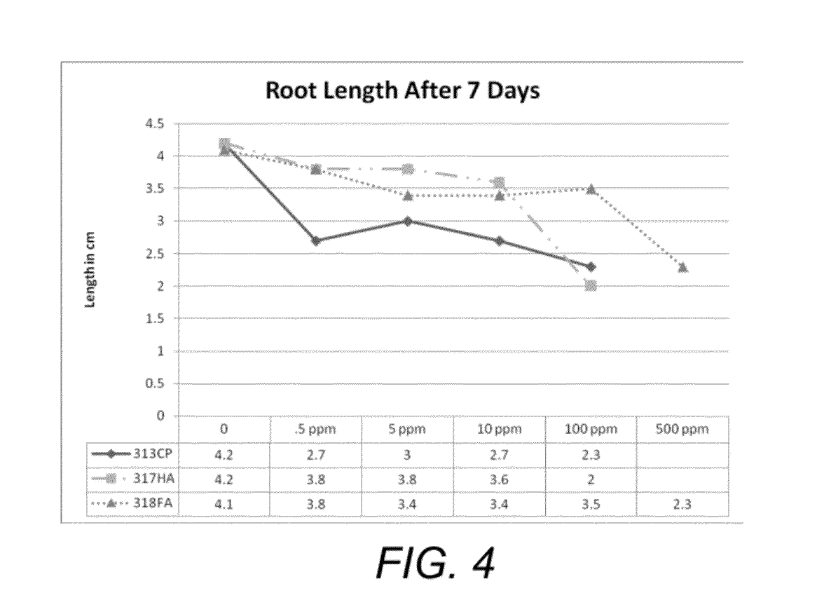

Seed Germination Results: For the germination portion of the experiment, the number of germinated seeds in each Petri dish was counted at the same time each day for 5 days, at which time virtually all seed had germinated. While none of the Samples significantly reduced the ultimate number of seeds which germinated at any concentration tested, there were obvious and statistically significant differences in the rate of germination as shown in FIGS. 2 to 4, which depict the numbers of germinated seed for each of the sample concentrations plotted versus time. A separate chart is used for each of the samples to show how the germination rate varied by concentration and by sample. The data shows that with certain samples, the germination rate of seed was inhibited. The addition of the NH4OH did not appear to substantially effect seed germination.

For metal-free Sample 313 CP and Comparative Sample 317HA, it can be seen that at all concentrations tested, there was a reduction in the number of germinated seed versus the control on day 2, however, when analyzed, these differences were significant using Tukey HSD at p<0.01, which indicated the metal-free CP was more effective in inhibiting seed germination than the HA sample. By day 3, the differences were smaller and not significant at p<0.05, but all concentrations had numerically fewer germinated seed. By day 4 there were virtually no differences in the number of germinated seed at any concentration versus the control and all seeds were germinated by day 5. Thus, both metal-free CP and metal-free HA show inhibition of germination, with metal-free CP providing statistically superior results.

For Comparative Sample 318FA however, the results were quite different. On day 2, only the two solutions with the highest FA concentration (100 and 500 ppm) reduced the number of germinated seed significantly (p<0.01). This same trend was still apparent on day 3 and on day 4 all seeds had germinated except for a few at the highest concentrations. Finally, on day 5 all but 2 out of 30 seeds at 500 ppm had germinated. It is not clear whether the higher concentration of metal-free FA are inhibiting or toxic.

The above results of the germination portion of the study were not predicted based upon previous studies with these materials and similar organic materials with metal ions present. Based on previous studies where the metal ions were not removed, the germination rates should have been faster than the control, not slower at the concentrations used. Thus, the presently disclosed experiment shows that for at least some NOM derived materials, removal of the native metals normally present provides for an inhibition of at least one biological process in seeds, e.g., germination. The presently disclosed data indicates that there is a significant difference between the metal-free CP, metal-free HA, and metal-free FA. For example, there appears to be differences in the concentration dependence of the metal-free NOMs at which the inhibition of germination occurs. For metal-free CP and metal-free HA germination inhibition is observed at the lowest concentration tested, but for the metal-free FA, there is no significant inhibition until above 100 ppm.

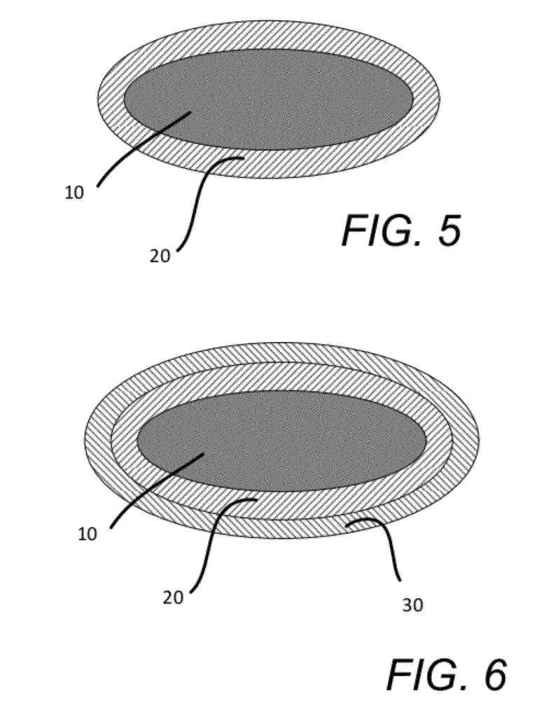

Root Length Results: The results of the root development portion of the experiment also yielded unpredicted results. Root length measurements were made for all seeds on day 7 after the initiation of the experiment. Each root was measured to the nearest mm and the values averaged for each sample concentration. Results are shown in FIG. 5. After 7 days, the germinated seeds from above germination study were removed from the Petri dishes and the root length was measured. Water with and without NH4OH gave longer root lengths than any of the Sample concentrations. The addition of the NH4OH did not appear to substantially effect root growth.

As shown in FIG. 5, the metal-free CP sample significantly reduced the average root length at 0.5, 5, and 10 ppm. There was a slight non-significant reduction in root length for the metal-free HA up to 10 ppm, and then a significant reduction in length at 100 ppm. For the metal-free FA, there was non-significant reduction in root length until the Carbon concentration was greater than 100 ppm. Based on previous studies with metal containing CP, HA, and FA samples, the root length was greater than the control at all concentrations. Thus, it was unpredicted that by removing the metal ions from these samples would provide for inhibition of root development. Metal-free CP demonstrated root growth inhibition at all concentrations tested (there were no statistically significant differences in root length for any of the concentrations used). In contrast, metal-free FA and metal-free HA demonstrated a threshold concentration above which there was significant inhibition of root growth.

The observed results were not predicted. Without being held to any particular theory, it is believed that metal-free CP and possibly other metal-free NOMs have a strong affinity for metal ions and may cause the metal ions in the seed/plant to be temporarily reduced. As metal ions in the plant which are essential for electron transfer in various metabolic processes, should these metal ions be complexed by the metal-free CP molecules (and possibly other metal-free NOMs) causing inhibition of one or more of the biological seed/plant processes, for example, germination and root elongation. It is noted that based on characterization data of CP verses HA and FA that HA and FA have fewer oxygen containing functional groups and likely have fewer binding sites than CP, so a higher concentration of HA and FA may be required to provide equivalent effects. Moreover, it is believed that HA behaves differently than FA because it has both more O containing functional groups and is much more aromatic, two structural differences that can provide for additional sites with likely affinity for metal ions.

### Seed Coatings

As depicted in FIG. 6, seed coatings and/or seed dressings comprising a seed 10 and a first layer 20 at least partially surrounding the seed 10 is provided. First layer 20 comprises an effective amount of metal-free CP or metal-free NOM so as to inhibit seed germination for a predetermined time. The metal-free CP or metal-free NOM can be contained in a polymer or other matrix that is configured for controlled degradation after sowing. Suitable polymers or matrixes include hydrogels, microgels, or sol-gels. Specific materials and methods of coatings seeds useful in this regard include such process and materials as used, for example, Intellicoat™ (Landec Inc., Indiana); ThermoSeed™ (Incotec, Netherlands) CelPril™ (Bayer CropScience); ApronMaxx™ (Syngenta); and Nacret™ (Syngenta). The metal-free CP, metal-free NOM, or other AI's (“actives”) can be provided and incorporated into the polymer or matrix, or directly adhered to the seed coat. The thickness of the polymer or matrix coating may be between from about 0.01 mils to about 10 mils in thickness. The polymer or matrix can be designed to release the actives in response to temperature, moisture content, sunlight, time, or combinations thereof. The polymer or matrix can quickly dissolve or disintegrate releasing the actives or can controllable release the actives over time or in response to a predetermined condition such as temperature, moisture content, sunlight, time, or combinations thereof. The polymer or matrix can be multi-layer, with discrete layers, for example, for disrupting the coating to allow moisture ingress, housing the actives, etc. In this configuration additional layers can be positioned in-between the seed and the metal free CP/NOM composition of matter. First layer 20 and any additional intervening layers can be configured for controlled degradation such that the biological inhibition effect is delayed after sowing. Additional agrochemical AI's as discussed above can be added to the metal-free CP or metal-free NOM material in the first layer 20 and/or an intervening layer.

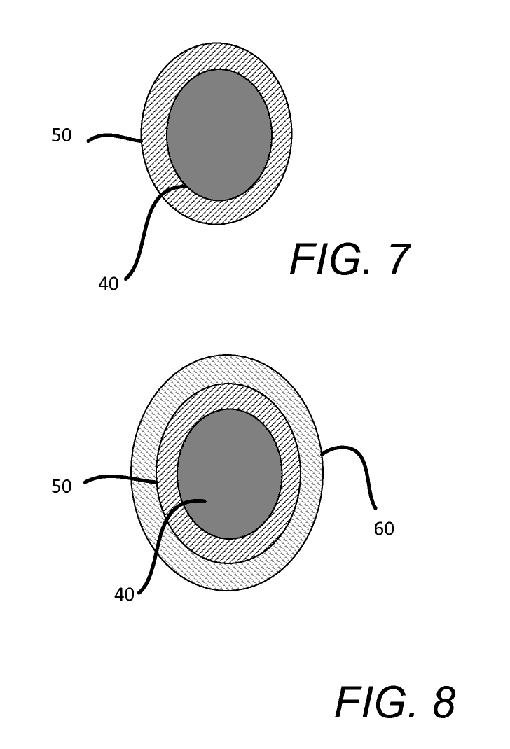

As depicted in FIG. 7, seed coatings and/or seed dressings comprising a seed 10 and a first layer 20 at least partially surrounding the seed 10 and second coating 30 is provided. First layer 20 comprises an effective amount of metal-free CP or metal-free NOM so as to inhibit seed germination for a predetermined time. The metal-free CP or metal-free NOM can be contained in a polymer or other matrix as described above that is configured for controlled degradation after sowing. In this configuration additional layers can be positioned in-between the seed and the metal free CP/NOM composition of matter. These additional intervening layers can also be configured for controlled degradation such that the inhibition effect is delayed after sowing. Second layer 30 comprises an effective amount of metal ions so as to reverse the inhibition effect of first layer 20. Second layer 30 can comprise a polymer or other matrix that is configured for controlled degradation at a predetermined time and/or a predetermined rate after sowing. In this configuration the reversal of inhibition can be concurrent or followed by an increase or improvement of a biological process upon re-introduction of metal ions to the metal-free CP or NOM. Additional, intervening layers can be positioned in-between the first layer 20 and the second layer 30. These additional intervening layers can also be configured for controlled degradation such that the release of metal ions is delayed after sowing for a predetermined time. Additional agrochemical AI's as discussed above can be added to the metal-free CP or metal-free NOM material in the first layer 20, the second layer 30, and/or an intervening layer. Additional layers, coloring, powders, and the like can be applied or used for the coated seeds. The coated seeds can then be sown to inhibit the seed's biological process and/or to first inhibit and then cease and/or restore or improve the seed's biological process.

### Coated Granular Forms for Foliar and Locus Application

In one aspect, a granular form is contacted with the metal-free CP or metal-free NOM to provide a composition of matter for providing inhibition of a plant biological process for a first predetermined time that can be following by the introduction of a fertilizing material at a second predetermined time. In one aspect, the composition of matter provides a controlled or delayed release form of the metal-free CP or metal-free NOM. Suitable granular forms can be clays and include, for example, montmorillonite, allapulgite, and hydrous aluminosilicate minerals. Montmorillonite mineral is from the non-swelling bentonite class of clays (e.g., from Ripley, Miss. and Mounds, Ill.). Montmorillonite has a low bulk density and high absorbtivity which allows higher liquid holding capacity of aqueous solutions of the metal-free CP or metal-free NOM. Attapulgite mineral, also known as Fuller's earth, is also from the non-swelling bentonite class and is obtained from Ochlocknee, Ga. Attapulgite's low bulk density and high absorbtivity allows higher liquid holding capacity of aqueous solutions of the metal-free CP or metal-free NOM. Hydrous aluminosilicate also has a low bulk density and high absorbtivity allowing for higher liquid holding capacity of aqueous solutions of the metal-free CP or metal-free NOM. Suitable clay granular forms for use with the metal-free CP or metal-free NOM as disclosed herein are available from Oil-Dri Corp. (Alpharetta, Ga.). The clay granule's micropore structure is adjusted to optimize the absorption and/or optimize release and/or optimize environmental stability of the metal-free CP or metal-free NOM for use in agriculture.

As depicted in FIG. 7, granular forms 40 and a first layer 50 at least partially surrounding the granular form 40. FIG. 8 depicts a second aspect of the granular form coated with first layer 50 and second coating 60. First layer 50 comprises an effective amount of metal ions, for example, an amount sufficient to cease or reverse the inhibition of a plant biological process. The metal ions can be contained/impregnated in a polymer or other matrix as described above that is configured for controlled degradation. While the term “layer” is used in reference to FIG. 8, the metal ions can be included in the granular form with or without a physical “layer” on the granular form. Second layer 60 comprises an effective amount of metal-free CP or metal-free NOM so as to inhibit a plant biological process for a predetermined time. The metal-free CP or metal-free NOM can be contained in a polymer or other matrix as described above that is configured for controlled degradation. In this configuration additional layers can be positioned in-between the granular form and the metal free CP/NOM composition of matter. These additional intervening layers can also be configured for controlled degradation such that the inhibition effect is delayed. In this configuration the reversal of inhibition can be concurrent or followed by an increase or improvement of a biological process upon re-introduction of metal ions to the metal-free CP or NOM. Additional, intervening layers can be positioned in-between the first layer 50 and the second layer 60. These additional intervening layers can also be configured for controlled degradation such that the release of metal ions is delayed for a predetermined time. Additional agrochemical AI's as discussed above can be added to the first layer 50, the second layer 60, and/or an intervening layer. Additional layers, colorants, processing aids, powders, and the like can be applied or used.

The relative surface pH of the particular clay granule may be acidic or basic, for example, between about 3 to about 11. The relative surface pH of the clay granule may be chosen to control the release of the metal-free CP or metal-free NOM and/or improve long-term bioavailability and/or delay release of an effective amount of the metal-free CP or metal-free NOM after application to the locus of a seed or plant. For example, clay granules with a relatively acidic surface chemistry typically have slower degradation and release properties than clay granules with a relatively basic surface chemistry. Application of the metal-free CP or metal-free NOM to a clay granular form of relatively acidic surface pH can provide for long-term bioavailability of the metal-free CP or metal-free NOM with little or no loss in the efficacy while providing for the delayed release of an effective amount of the metal-free CP or metal-free NOM as compared to direct soil application of the metal-free CP or metal-free NOM.

In certain aspects, slow release granules having a pH of about 4 to about 6 with the metal-free CP or metal-free NOM can be used to improve sown seed and/or plant health, growth or pest-resistance and or the delayed release of an effective amount of the metal-free CP or metal-free NOM. In other aspects, combinations of fast release clay granules having a pH of about 9 to about 10 and slow release granules having a pH of about 4 to about 6 with the metal-free CP or metal-free NOM are used to improve the health, growth or pest-resistance of a sown seed and/or plant. Such combinations of acidic/basic granular forms provides for essentially the immediate release of an effective amount of the metal-free CP or metal-free NOM followed by the delayed release of an effective amount of the metal-free CP or metal-free NOM at a predetermined latter time.

In one aspect, the metal-free CP or metal-free NOM can be sprayed onto the clay granules and/or first layer 50 and dried. In another aspect, the clay granules with or without first layer 50 can be tumbled with the metal-free CP or metal-free NOM, or a fluidized bed may be used. The treated clay granular form can then be applied to the locus of a sown seed and/or plant to inhibit a plant biological process and/or to first inhibit and then cease and/or restore or improve the plant biological process.

In another aspect, the clay granular form may be applied to the locus of a sown seed or a plant and the metal-free CP or metal-free NOM can be applied essentially to the same locus, whereas at least a portion of clay granulate will be contacted with the metal-free CP or metal-free NOM to provide essentially an instant release of an effective amount of the metal-free CP or metal-free NOM to the soil and/or foliage, followed by the delayed release of an effective amount of the metal-free CP or metal-free NOM to the locus at a predetermined latter time.

In one aspect, the clay granular form is contacted with the metal-free CP or metal-free NOM combined with, or sequentially contacted by, a second component to provide a subsequent treatment for improved health, growth or stress-resistance of a sown seed or plant. In another aspect, the clay granular form can be contacted with the metal-free CP or metal-free NOM or at least one second component in sequential order to maximize the effectiveness of either component or to minimize interactions of the components and/or the clay granular form.

In one aspect, the clay granular form contacted with the metal-free CP or metal-free NOM and optionally the second component is applied to the locus essentially simultaneously with the seed, for example, as the seed is sown.

Granular Forms of Urea with Metal-Free CP or Metal Free NOM

In one aspect, the granular form comprises urea. The granular urea with or without first coating 50 is contacted with the metal-free CP or metal-free NOM to provide a composition of matter of manufacture suitable for agricultural use. In one aspect, the granular form is a Sulfur-Coated Urea (SCU) or a Polymer-Coated Urea (PCU or ESN), herein after collectively referred to as urea granular form.

Sulfur-Coated Urea (SCU) is a controlled-release nitrogen fertilizer typically providing a NPK analysis of about 25-0-0 to about 38-0-0, and about 10-30% sulfur. SCU's typically are designed such that a quick-releasing form of nitrogen (such as urea) is provided for fast green-up and immediate feeding and a slow-release form are provided for longer-lasting nourishment.

SCU sulfur-coated urea granular form can be prepared in a number of ways, typically by spraying preheated urea granules with molten sulfur and optionally a wax. The thickness of the sulfur coating can be controlled for optimizing handling, in-loading, shipping, blending and bagging and to reduce premature break down and release of all the nitrogen at one time. SCU granules are available commerically in different granular sizes. Suitable SCU include, for example, Nu-Gro Technologies SCU® (Ontario, Canada).

In one aspect, the metal-free CP or metal-free NOM can be sprayed onto the SCU granules with or without first coating 50 and dried. In another aspect, the SCU granules with or without first layer 50 can be tumbled with the metal-free CP or metal-free NOM, or a fluidized bed may be used. The treated SCU granules can then be applied to the locus of a sown seed and/or plant to improve its health, growth or pest-resistance. In another aspect, the SCU granular form may be applied to the locus of a sown seed or a plant and the metal-free CP or metal-free NOM can be applied essentially to the same locus, whereas at least a portion of SCU granular form will be contacted with the metal-free CP or metal-free NOM to provide essentially an instant soil and/or foliage treatment of an effective amount of the metal-free CP or metal-free NOM and a delayed release of an effective amount of either the metal ions or of CP, NOM, or other AI to the locus at a predetermined latter time.

Coating urea with sulfur and subsequent contact with the metal-free CP or metal-free NOM provides for controlled-release of a nitrogen source and a sulfur source post-inhibition after contact with the metal-free CP or metal-free NOM so as to cease, restore and/or improve improved health, growth or stress-resistance of a sown seed or plant. In one aspect, the sulfur-coated urea contacted with the metal-free CP or metal-free NOM can provide for inhibition of a biological process of a sown seed or plant essentially immediately, and/or then provide for fertilizing continuing up to about eight, nine, ten, eleven, or to about 12 weeks or more post-application, depending on environmental conditions.

In one aspect, the metal-free CP or metal-free NOM is combined with an additional AI and the combination is contacted with the SCU granulate to provide a treatment for improved health, growth or stress-resistance of a sown seed or plant. In another aspect, the SCU particulate can be contacted with the metal-free CP or metal-free NOM or at least one second component in sequential order to maximize the effectiveness of either component or to minimize interactions of the components and/or the SCU particulate.

Polymer Coated Urea Treated with Metal Free CP or Metal-Free NOM

In one aspect, a Polymer-Coated Urea (PCU or ESN) granulate is contacted with the metal-free CP or metal-free NOM to provide a controlled release form of the metal-free CP or metal-free NOM in combination with a fertilizer. Polymer-Coated Urea (PCU or ESN) is a controlled-release nitrogen fertilizer typically providing a NPK analysis similar to a SCU without the sulfur. PCU's typically are designed such that a quick-releasing form of nitrogen (such as urea) is provided for fast green-up and immediate feeding and a slow-release form are provided for longer-lasting nourishment. The metal ion layer 50 can be used or the metal ions can be incorporated in the polymer coating the urea granular form.

PCU-coated urea can be prepared in a number of ways, typically by spraying urea granules with polymer solutions and drying. The thickness of the polymer coating can be controlled for optimizing handling—in loading, shipping, blending and bagging and to modify or adjust the release rate of the urea. For example, the release rate of the urea may be controlled by adjusting the polymer chemistry and/or polymer coating thickness. Polymer coating chemistry can be adjusted to control release of urea based on temperature and/or moisture. The polymer coating may be biodegradable or remain intact during or after urea release. Suitable PCU include, for example, POLYCON, ESN® Smart Nitrogen (Agrium Inc., Calgary, Canada).

In one aspect, the metal-free CP or metal-free NOM and the metal ion layer can be sprayed onto the PCU granulate and dried. In another aspect, the PCU granulate with the first layer 50 can be tumbled with the metal-free CP or metal-free NOM, or a fluidized bed may be used. The metal-free CP or metal-free NOM can form a coating on the first layer 50, the polymer, penetrate the polymer coating, or all of these. In one aspect, the metal-free CP or metal-free NOM can be mixed or otherwise dispersed or blended with the polymer prior to coating the urea granulate.

In another aspect, the PCU granular form may be applied to the locus of a sown seed or a plant and the metal-free CP or metal-free NOM can be applied essentially to the same locus, whereas at least a portion of PCU granular form will be contacted with the metal-free CP or metal-free NOM to provide essentially an instant soil and/or foliage treatment of an effective amount of the metal-free CP or metal-free NOM and a delayed release of an effective amount of the metal-free CP or metal-free NOM to the locus at a predetermined latter time.

In another aspect, the metal-free CP or metal-free NOM is combined with another AI and the combination is contacted with the PCU granulate (or mixed with the polymer coating prior to coating of the urea particulate) to provide a treatment for improved health, growth or stress-resistance of a sown seed or plant. In another aspect, the PCU particulate can be contacted with the metal-free CP or metal-free NOM or at least one second component in sequential order to maximize the effectiveness of either component or to minimize interactions of the components and/or the PCU particulate.

Polymer coating urea with a polymer containing the metal-free CP or metal-free NOM or subsequent contact of the polymer coated urea with the metal-free CP or metal-free NOM provides for controlled-release of a nitrogen source in combination with the metal-free CP or metal-free NOM for improved health, growth or stress-resistance of a sown seed or plant. Typically, polymer-coated urea contacted with the metal-free CP or metal-free NOM can provide for an inhibition of a plant biological process followed br ceasing, reversing and/or improving the health, growth or stress-resistance of a sown seed or plant essentially immediately thereafter, continuing up to about eight, nine, ten, eleven, or to about 12 weeks or more post-application, depending on environmental conditions. A sustained, controlled release of and nitrogen in combination with the metal-free CP or metal-free NOM provides for the enhanced uptake of other nutrients essential for growth, and disease resistance. The controlled-release composition comprising the PCU contacted with the metal-free CP or metal-free NOM can reduce the total number of applications and/or prevent plant injury.

In another aspect, the urea granular form (SCU or PCU) is used in combination with the clay granular form disclosed above, provided that at least one of the granular forms are contacted with the metal-free CP or metal-free NOM either initially or subsequently to application to a locus, to provide a controlled release form of an effective amount of the metal-free CP or metal-free NOM in combination with a fertilizer. Such combinations of clay granular forms and urea granular forms can provide essentially an instant of an effective amount of the metal-free CP or metal-free NOM to the locus with fertilizer, and a delayed release to the soil and/or foliage of an effective amount of SCU or PCU at a predetermined latter time.

Other forms of urea may be sulfur- or polymer-coated, substituted for, or combined with SCU for the practice of the disclosure herein, including coated or uncoated granular forms of urea formaldehyde (UF) and/or methylene urea (MU), for example, Formolene, FLUF, Nitro 26 CRN, Nitroform, or CoRoN). The releasing properties of the UF and MU may be controlled by adjusting the N-C-N chain length of the material. Various types of cold water soluble nitrogen (CWSN), cold water insoluble nitrogen (CWIN) and hot water insoluble nitrogen (HWIN) forms of urea and combinations thereof may be used. Isobutylene diurea (IBDU) may be used. Various processing aids may be used to assist contacting the metal-free CP or metal-free NOM with the clay or urea granular form. Such processing aids include penetrants such as dimethylsulfoxide (DMSO), alcohols, oils, tackifiers, emulsifiers, dispersants, adhesion promoters, defoamers, etc, as are generally known and practiced. Processes for preparing a composition disclosed and described herein typically involve simple admixture of the components and the granular form. Order of addition is not generally critical. In one aspect, the amount of metal-free CP or metal-free NOM applied to the granule is chosen such that an amount of granule sufficient to uniformly cover a locus of sown seed or plant using dispensing equipment is provided. Such amounts of metal-free CP or metal-free NOM as a.i. relative to the weight of granular form is readily determined without undue experimentation by any person skilled in the art or by following the exemplary guidelines set forth in this application.

### Methods

Methods of use of the composition as described herein for soil and/or foliage treatment providing nutrition and/or for reducing susceptibility to disease of a plant are further disclosed. The granular forms (clay, SCU, PCU, etc.) with or without first layer 50 treated with at least the metal-free CP or metal-free NOM, optionally with at least one second component (herein after referred to as “treated granular form”) can be applied to a single plant (e.g., a houseplant or garden ornamental), to an assemblage of plants occupying an area, or to a locus of sown seed or plant. The treated granular form can be combined with seed as the seed is introduced into or on soil or other growing media or the treated granular form can be applied to the locus after sowing or to the locus of emerged plants.

The aforementioned experimental results show that metal-free CP can inhibit biological processes in seed/plants. This inhibition can, for example, delay or postpone the germination of seeds.

All patents and publications cited herein are incorporated by reference into this application in their entirety. The words “comprise”, “comprises”, and “comprising” are to be interpreted inclusively rather than exclusively.

1. A method of inhibiting the rate of at least one biological process in a seed or plant, the method comprising contacting a part of a seed, a plant, or the locus thereof with a composition of matter, the composition of matter comprising an agriculturally acceptable complex mixture of natural organic matter (NOM) substantially devoid of one or more metal ions essential for the at least one biological process in the seed or plant.

2. The method of claim 1, wherein the natural organic matter is partially humified.

3. The method of claim 1, wherein the natural organic matter is characterized by at least two of:
a. a mixture of condensed hydrocarbons, lignins, and tannins and/or condensed tannins;
b. a oxygen-to-carbon ratio for the dissolved organic matter of greater than about 0.5;
c. a total number of tannin compounds greater than about 200, the tannin compounds having a hydrogen to carbon ration of about 0.5 to about 1.4, and an aromaticity index of less than about 0.7 as measured by mass spectroscopy; or
d. a mass distribution of about 55-60% lignin compounds, 27-35% tannin compounds, and about 8-15% condensed hydrocarbon as measured by mass spectroscopy.

4. The method of claim 3, wherein the composition of matter is characterized by comprising a mixture of condensed hydrocarbons, lignins, and tannins and/or condensed tannins, characterized in that at least 10% of the total % of compounds of the composition are tannins and/or condensed tannins.

5. The method of claim 3, wherein the composition of matter is characterized by comprising a mixture of condensed hydrocarbons, lignins, and tannins and/or condensed tannins, characterized in that at least 20% of the total % of compounds of the composition are tannins and/or condensed tannins.

6. The method of claim 3, wherein biological process is inhibited for a first predetermined time.

7. The method of claim 4, wherein the inhibition rate of said at least one biological process in the plant is ceased or reversed after a second predetermined time.

8. The method of claim 1, wherein said composition of matter is substantially devoid of at least one transitional metal ion.

9. The method of claim 8, wherein said composition of matter is substantially devoid of at least one of ferrous/ferric ions; manganese ions; copper ions; magnesium ions; and zinc ions.

10. The method of claim 1, wherein the composition of matter inhibits at least one biological process requiring a metal ion or metal ion transport.

11. The method of claim 1, wherein the rate of germination and/or the rate of root development is inhibited for a first predetermined time.

12. The method of claim 11, wherein the inhibition of the rate of germination and/or the rate of root development is ceased or reversed after a second predetermined time.

13. A composition of matter comprising a mixture of compounds derived from natural organic matter (NOM) that is substantially devoid of metal ions.

14. The composition of matter of claim 13, wherein the mixture of compounds derived from natural organic matter (NOM) are substantially devoid of transition metal ions.

15. The composition of matter of claim 13, wherein the natural organic matter (NOM) comprises functionality capable of chelating at least one transition metal ion.

16. The composition of matter of claim 13, wherein the natural organic matter (NOM) is partially humified.

17. The composition of matter of claim 16, wherein said composition of matter is characterized by two or more of
a. a mixture of condensed hydrocarbons, lignins, and tannins and/or condensed tannins;
b. a oxygen-to-carbon ratio for the dissolved organic matter of greater than about 0.5;
c. a total number of tannin compounds greater than about 200, the tannin compounds having a hydrogen to carbon ration of about 0.5 to about 1.4, and an aromaticity index of less than about 0.7 as measured by mass spectroscopy; and
d. a mass distribution of about 55-60% lignin compounds, 27-35% tannin compounds, and about 8-15% condensed hydrocarbon as measured by mass spectroscopy.

18. The composition of matter of claim 17, wherein the composition of matter is characterized by comprising a mixture of condensed hydrocarbons, lignins, and tannins and/or condensed tannins,
characterized in that at least 10% of the total % of compounds of the composition are tannins and/or condensed tannins.

19. The composition of matter of matter of claim 17, wherein the composition of matter is characterized by comprising a mixture of condensed hydrocarbons, lignins, and tannins and/or condensed tannins, characterized in that at least 20% of the total % of compounds of the composition are tannins and/or condensed tannins.

20. The composition of matter of claim 13, wherein the natural organic matter (NOM) is metal-free humic acid (HA).

21. The composition of matter of claim 13, wherein the natural organic matter (NOM) is metal free fulvic acid (FA).

22. A seed contacted with the composition of matter of claim 13.

23. The seed of claim 22, further comprising a first coating, the first coating at least partially surrounding said seed.

24. The seed of claim 23, further comprising a second coating, the second coating at least partially surrounding the first coating and comprising a source of at least one metal ion.

25. The seed of claim 24, wherein the first coating and/or the second coating is configured to degrade after said seed is sown.

26. The seed of claim 25, wherein the first coating degrades at a first predetermined time or rate, and the second coating degrades at a second predetermined time or rate.

27. A granular form contacted with the composition of matter of claim 13.

28. The granular form of claim 27, further comprising a first coating, the first coating at least partially surrounding said granular form and comprising a source of at least one metal ion.

29. The granular form of claim 28, further comprising a second coating, the second coating at least partially surrounding the first coating.

30. The granular form of claim 29, wherein the first coating and/or the second coating is configured to degrade after said seed is sown.

31. The granular form of claim 30, wherein the first coating degrades at a first predetermined time or rate, and the second coating degrades at a second predetermined time or rate.

32. A method of inhibiting the rate of at least one biological process in a seed or plant, the method comprising contacting a part of a seed, a plant, or the locus thereof with a composition of matter, the composition of matter comprising an agriculturally acceptable complex mixture of partially humified natural organic matter (NOM) substantially devoid of one or more metal ions essential for the at least one biological process in the seed or plant,
wherein the partially humified natural organic matter is characterized by at least two of:
a. a mixture of condensed hydrocarbons, lignins, and tannins and/or condensed tannins;
b. a oxygen-to-carbon ratio for the dissolved organic matter of greater than about 0.5;
c. a total number of tannin compounds greater than about 200, the tannin compounds having a hydrogen to carbon ration of about 0.5 to about 1.4, and an aromaticity index of less than about 0.7 as measured by mass spectroscopy; and
d. a mass distribution of about 55-60% lignin compounds, 27-35% tannin compounds, and about 8-15% condensed hydrocarbon as measured by mass spectroscopy.
